(19) United States
(12) Patent Application Publication
(10) Pub. No.: US 2003/0016919 A1
(43) Pub. Date: Jan. 23, 2003

(54) Substrate for opto-electronic assembly

(75) Inventors: Michael Burmeister, Minden (DE); Karl Gerdom, Lubbecke (DE)

Correspondence Address: Norman P. Soloway, HAYES SOLOWAY, P.C., 130 W. Cushing Street, Tucson, AZ, 85701, US

(73) Assignee: HARTING Elektro-optische Bauteile GmbH & Co. KG.

(21) Appl. No.: 10/195,248

(22) Filed: Jul. 15, 2002

(30) Foreign Application Priority Data
Jul. 17, 2001 (DE) 101 34 637.9

(51) Int. Cl. G02B 6/42; G02B 6/43; G02B 6/30

(52) U.S. Cl. 385/88; 385/89; 385/49

(57) ABSTRACT

A substrate for an opto-electronic assembly comprises at least one receiving structure for an optical waveguide and at least one positioning structure for an opto-electronic component.

### TECHNICAL FIELD

The invention relates to a substrate for an electro-optical component, comprising at least one receiving structure for an optical waveguide.

### BACKGROUND OF THE INVENTION

In order to obtain an opto-electronic transducer by using such a substrate, an opto-electronic component has to be arranged on the substrate, e g. a transmitting diode or a receiving diode. As seen relative to the light exit surface area of the optical waveguide accommodated in the receiving structure of the substrate, the above mentioned diode is arranged in such a way that light from the optical waveguide impinges on the active surface of an electro-optical component that serves as a receiver; vice versa, the light that comes from the active surface of an electro-optical component that serves as a transmitter, is coupled into the optical waveguide.

In order to minimize the loss that occurs during the optical coupling of the optical waveguide with the electro-optical components, the opto-electronic components have to be arranged relative to the end face of the optical waveguide as precisely as possible. A positioning accuracy in a tolerance range of few micrometers is required in all three directions in space Such an exact positioning is required particularly in case if opto-electronic components such as surface-sensitive receiving components and surface-emitting transmitting components, e.g. vertically emitting laser diodes (VCSEL), are used. Such laser diodes, produced by epitaxial deposition methods, have a conical beam shape which is very suitable for being coupled into an optical waveguide.

The object of the invention is to position opto-electronic components with maximum precision relative to the receiving structure in the substrate and, hence, to an optical waveguide arranged in the receiving structure.

### BRIEF SUMMARY OF THE INVENTION

According to the invention, a substrate for an opto-electronic assembly comprises at least one receiving structure for an optical waveguide and at least one positioning structure for an opto-electronic component. In common terms, the invention is based on the basic idea to passively position the opto-electronic component by means of positioning structures that are formed in one piece with the substrate. Thus, the positioning structures are formed during producing the substrate in one and the same working step like the receiving structure for the optical waveguide, so that the receiving structure and the positioning structure on the substrate always have the same positional relationship to each other, even in the case of industrial production, i.e. that there are no variations with respect to the relative position of receiving structure and positioning structure. Synthetic material forming methods are particularly suitable for producing such a substrate having receiving and positioning structures, in which the shape of the substrate e.g. in the nature of an injection-molded circuit board - is taken from a casting mold. Therefore, a possibly high expenditure for the precise arrangement of receiving structure and positioning structure has to be made only once, namely during manufacturing the casting mold.

A positioning groove having a V-shaped cross-section is particularly suitable as positioning structure for the opto-electronic component. Such a positioning structure makes it possible that the opto-electronic component is self-centered upon insertion in the positioning structure, which facilitates the passive positioning.

In a substrate in which a plurality of receiving structures is arranged side by side in parallelism, there may be arranged positioning structures which in each case are adjacent to an end face of the receiving structure. With this design, each opto-electronic component associated to an optical waveguide arranged in the receiving structure is positioned individually. In this way a particularly high precision is achieved.

As an alternative there may be provided for that, for instance, only one positioning structure is provided at the side of the several receiving structures, or that two positioning structures are provided, namely one on the one side of the several receiving structures and the other on the other side. This design is particularly suitable in case if the opto-electronic components are combined into an assembly in which the individual opto-electronic components are arranged with very high precision relative to each other. In this case it will be sufficient to fix the position of the entire assembly by a single positioning structure or also by two positioning structures, that is/are arranged at the side of the receiving structures

According to a preferred embodiment, a plurality of receiving structures is arranged side by side in parallelism, which open into a continuous trench for receiving a plurality of opto-electronic components. The opto-electronic components, in particular vertically emitting laser diodes, may be arranged in this trench so as to be “upright”, i.e. in such a manner that their active surface is directly facing the end face of an optical waveguide arranged in the receiving structure. With this design, the mirrors known from prior art may be omitted, which would be required with the conventional, “horizontal” arrangement of the opto-electronic components, for coupling the light which is delivered by them into the optical waveguide, and vice versa With this, a particularly space-saving, flat construction is achieved.

According to one embodiment of the invention it is provided for that in addition to the receiving structure for the optical waveguide, there is provided at least one guiding structure by means of which a plug connector ferrule can be attached to the substrate. This makes it possible to position the plug connector ferrule without a large expenditure on the substrate in such a manner that the waveguides of the ferrule are coupled with the waveguides of the substrate in a very reliable way and with a low attenuation factor.

Further designs of the invention will be apparent from the sub-claims

### BRIEF DESCRIPTION OF THE DRAWINGS

FIG. 1 shows a substrate according to a first embodiment with inserted optical waveguides, in a section along plane I of FIG. 3;

FIG. 2 shows a perspective view of an assembly of opto-electronic components;

FIG. 3 shows a longitudinal section through the substrate of FIG. 1 with the optical waveguide inserted and an opto-electronic component arranged;

FIG. 4 shows a longitudinal section along plane IV-IV of FIG. 5 through a substrate according to a second embodiment with a plug connector ferrule put in place;

FIG. 5 shows a top view onto the substrate and the plug connector ferrule of FIG. 4; and

FIG. 6 shows a perspective sectional view along plane VI-VI of FIG. 5.

### DETAILED DESCRIPTION OF THE PREFERRED EMBODIMENTS

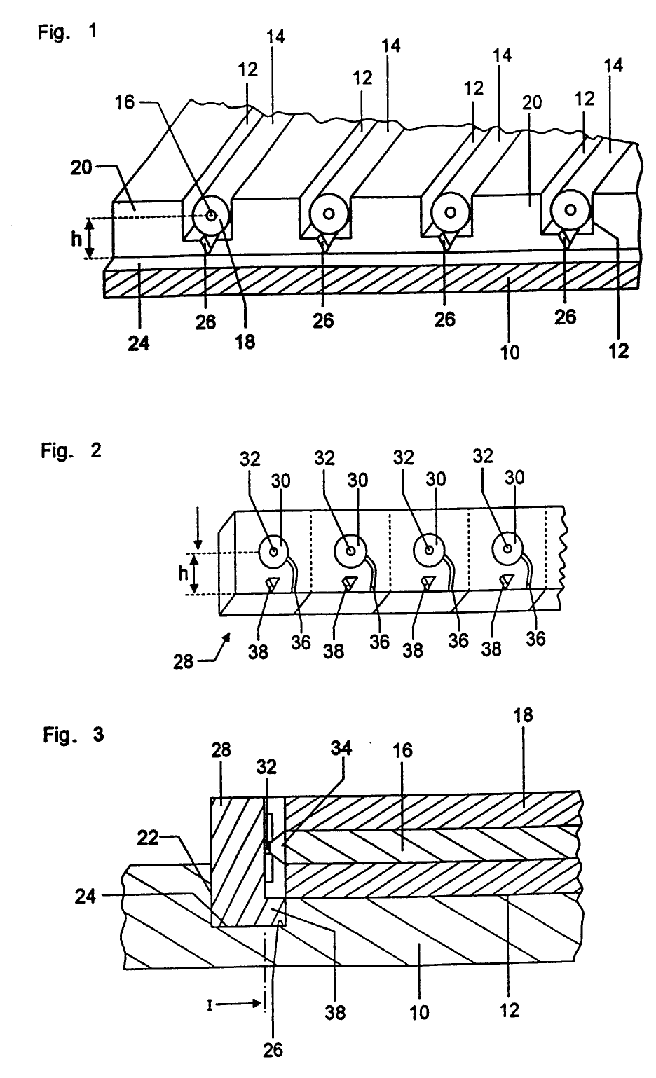

In FIGS. 1 and 3 there can be seen a substrate 10 according to a first embodiment, which is provided with a plurality of parallel receiving structures 12 for optical waveguides. Each of the receiving structures 12 is configured here in the nature of a receiving groove having a square cross-section. Instead of the square cross-section, the receiving groove could also have a V-shaped cross-section, for example.

In each of the receiving grooves 12, there is arranged one optical waveguide which in this arrangement is configured as an optical fiber 14. Each optical fiber 14 consists in a known manner of a core 16 and a sheathing 18. The optical fibers can be glued in the receiving structures.

The receiving structures 12 open into a trench which is formed by two side walls 20, 22 and a bottom 24. The trench extends perpendicularly to the longitudinal direction of the receiving structures 12, the height of the side wall 22 being smaller than the height of the side wall 20 This can be seen by comparing FIGS. 1 and 3; the side wall 20 has such a height that, at the side of the optical waveguides, the upper side of the substrate is approximately flush with these, whereas the upper side of the substrate adjacent to the side wall 22 lies underneath a level defined by the optical waveguides.

A positioning structure 26 is provided in the side wall 20 of the trench in the region of the end face of each receiving grooves 12, namely in that region where this opens into the trench and the end face of the optical fiber, arranged in the corresponding receiving structure, lies; this positioning structure is configured as a V-shaped groove here. The bottom of the V-shaped groove is situated at the same level than the bottom 24 of the trench in the substrate The optical fibers 14 are arranged in the receiving structures 12 such that they precisely terminate flush with the vertical end face (shown in FIG. 1) of the positioning structure 26.

An assembly 28 (see FIG. 2) is arranged in the trench between the walls 20, 22, this assembly consisting of a plurality of opto-electronic components 30 arranged side by side. In the example illustrated, these each are vertically emitting laser diodes (VCSEL) which are produced by epitaxial deposition methods, their active surfaces 32 being able to deliver a cone-shaped light beam 34 (see FIG. 3) For making contact, there is provided a conductor track 36 which is formed on the surface of the assembly 28. A second conductor track extends right through the assembly 28, so that the opto-electronic components 30 can be contacted from the rear side of the assembly 28.

Each opto-electronic component 30 is provided with an adjustment structure 38 which is configured here as a projection having a triangular cross-section The cross-section is complementary with the shape of the V-shaped positioning structure 26. The mutual distance of the adjustment structures 38 corresponds to the distance of the various positioning structures 26 in the substrate. The height h between the deepest point of each adjustment structure 38 and the center of the active surface 32 of each opto-electronic component corresponds to the distance h between the deepest point of each positioning structure 26 and the center of the core 16 of each optical fiber 14. As can be seen in FIG. 3, the assembly 28 is arranged in the trench between the walls 20, 22 and on the bottom 24 in such a way that the adjustment structure 38, which is provided on the opto-electronic component 30, engages into the positioning structure 26 in the substrate. The active surface 32 of each opto-electronic component 30 lies here precisely opposite the center of the core 16 of the optical fibers 14 arranged in the receiving structures 12, so that a direct, loss-free optical coupling is ensured.

If semiconductor components are concerned, the adjustment structures 38 of the opto-electronic components 30 can be configured as structures which are directly grown in an epitaxial method.

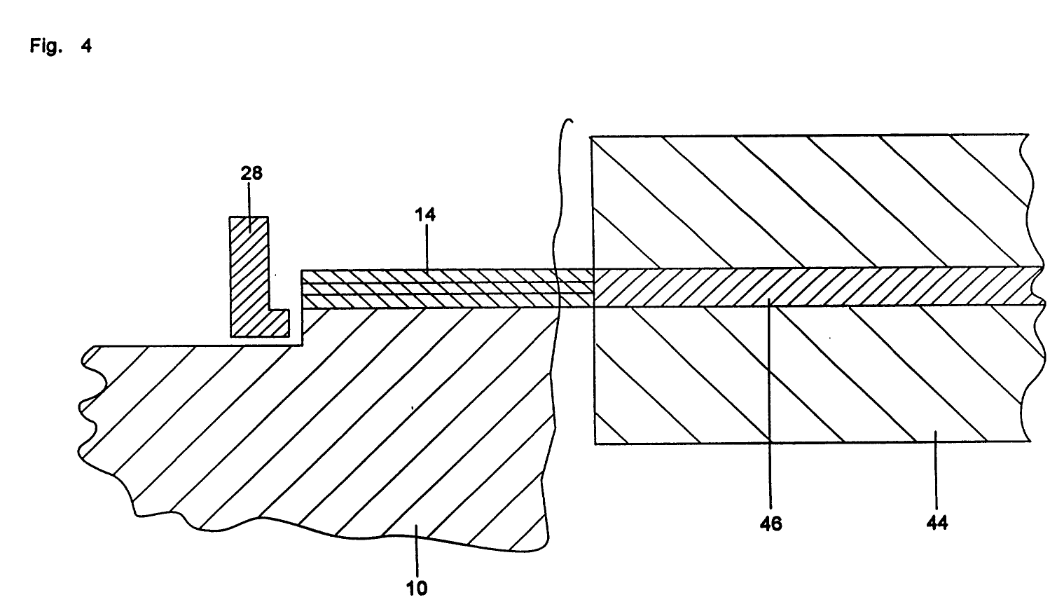

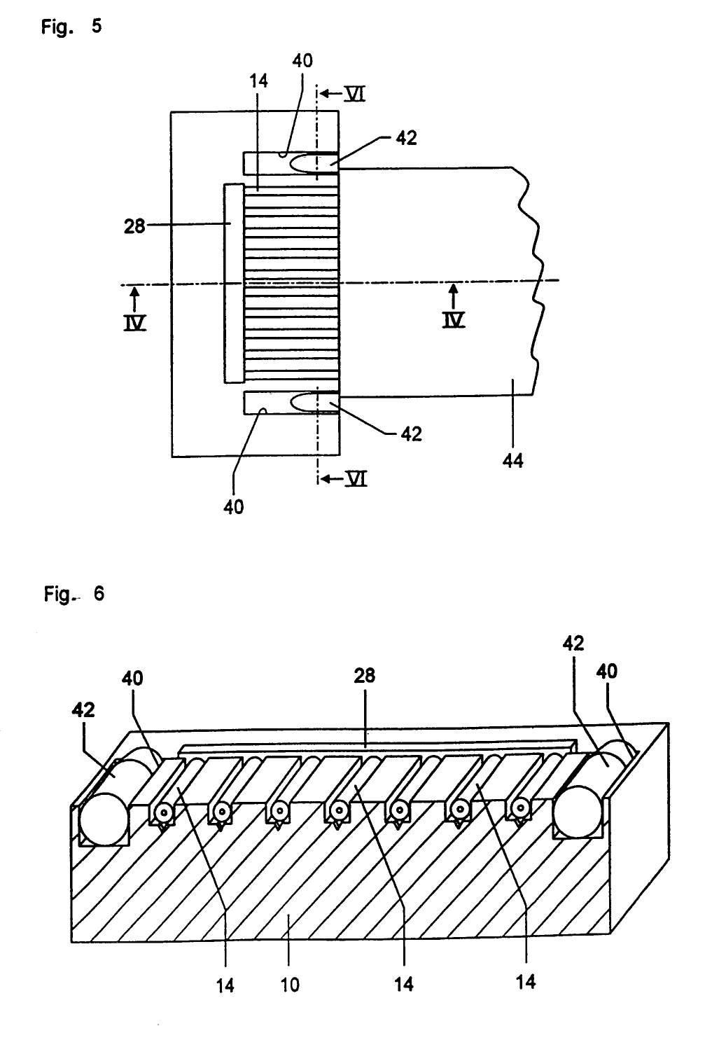

In FIGS. 4 to 6 there can be seen a substrate according to a second embodiment. Unlike the first embodiment, the substrate 10, in addition to the receiving structures 12 for the optical fibers, is provided with two guiding structures 40 which here are formed as grooves having a square cross-section. The guiding structures 40 serve for receiving guiding pins 42 which are formed on a plug connector ferrule 44. The guiding structures are also produced with the same precision relative to the receiving structures as the positioning structures.

The plug connector ferrule 44 is a MT plug connector ferrule which is provided with a plurality of lightwave components 46 arranged side by side. The distance between the lightwave components 46 in the MT plug connector ferrule corresponds to the distance between the optical fibers 14 in the substrate.

When the two guiding pins 42 of the plug connector ferrule are inserted into the guiding structures 40 of the substrate 10, the end faces of the lightwave components 46 of the plug connector ferrule automatically align with the end faces of the optical fibers 14 in the substrate, so that there will be produced a reliable and low-loss optical coupling between the plug connector ferrule and the optical fibers of the substrate and, hence, with the opto-electronic components 30

1. A substrate for an opto-electronic assembly, said substrate comprising at least one receiving structure for an optical waveguide and at least one positioning structure for an opto-electronic component

2. The substrate according to claim 1, wherein said receiving structure. consists in a receiving groove.

3. The substrate according to claim 2, wherein said positioning structure consists in a positioning groove.

4. The substrate according to claim 3, wherein said positioning groove has a V-shaped cross-section.

5. The substrate according to claim 1, wherein a plurality of receiving structures is arranged side by side in parallelism, which open into a continuous trench for receiving a plurality of opto-electronic components.

6. The substrate according to claim 1, wherein said positioning structure is arranged so as to adjoin an end face of said receiving structure.

7. The substrate according to claim 1, wherein said positioning structure is arranged to one side of an end face of said receiving structure.

8. The substrate according to claim 1, wherein at least one opto-electronic component is provided which has an adjustment structure engaging into said positioning structure of said substrate.

9. The substrate according to claim 8, wherein said opto-electronic component is a surface-sensitive receiving element.

10. The substrate according to claim 8, wherein said opto-electronic component is a surface-emitting transmitting element.

11. The substrate according to claim 8, wherein a plurality of opto-electronic components is provided which are combined into an assembly.

12. The substrate according to claim 8, wherein an active surface of said at least one opto-electronic component directly radiates on an end face of optical waveguides which are arranged in said receiving structures.

13. The substrate according to claim 8, wherein an active surface of said at least one opto-electronic component is directly exposed to radiation from an end face of optical waveguides which are arranged in said receiving structures.

14. The substrate according to claim 1, wherein in addition to said receiving structure for said optical waveguide, there is provided at least one guiding structure by means of which a plug connector ferrule can be attached to said substrate.

15. The substrate according to claim 1, wherein said plug connector ferrule is a MT plug connector ferrule and wherein two guiding structures are provided on said substrate which are aligned so as to be parallel to each other.

16. The substrate according to claim 1, wherein said substrate is made of synthetic material and is produced by means of a forming method.
